(19) United States
(12) Patent Application Publication
(10) Pub. No.: US 2009/0136735 A1
(43) Pub. Date: May 28, 2009

(54) METHOD AND DEVICE FOR PRODUCING A MOULDED PART WITH AN OPENING GROOVE AND MOULDED PART

(75) Inventors: Willi Bianchi, Luneburg (DE); Ralf Coordes, Abensberg (DE)

Correspondence Address: URSULA B. DAY, ESQ., 708 Third Avenue, SUITE 1501, NEW YORK, NY, 10017, US

(73) Assignee: Peguform GmbH, 79268 Botzingen (DE)

(21) Appl. No.: 12/299,954

(22) PCT Filed: May 8, 2007
(86) PCT No.: PCT/EP2007/004069

§ 371 Date: Nov. 7, 2008

(30) Foreign Application Priority Data
May 10, 2006 (DE) 10 2006 021 999.6

(51) Int. Cl. B32B 5/20; B29C 45/03; B29C 45/14

(52) U.S. Cl. 428/304.4; 264/45.5; 425/542

(57) ABSTRACT

The present invention relates to a method for producing a molded part 1 having an opening groove 10 for an air bag deployment opening, comprising a support part 2 and a molded skin 3 and also a foamed layer 8 between the support part 2 and the molded skin 3, wherein in the first step, a groove 5 is formed during the injection molding of the support part 2 and, wherein this groove 5, in a second step of filling the molded part 1 is being enlarged in the foam 8 by means of a slider 7, whereby an opening groove for the air bag is formed.

The present invention refers to a method for producing molded parts made substantially of plastic and which include an opening groove for an air bag unfolding opening in air bag systems for interiors of motor vehicles.

The invention also refers to a device for producing molded parts which includes an opening groove for an air bag unfolding opening in air bag systems for motor vehicles, and molded parts produced according to the afore-stated method.

Such molded parts are for example configured as dash boards or door panelings in a motor vehicle and are known from numerous publications. Door panelings and dashboards not only cover the electric lines or similar devices that are relevant for the functioning of the motor vehicle, but also more frequently security systems such as for example air bag modules. Such door panelings or dash boards covering air bag modules in general include a support part made from thermoplastic material and a molded skin, whereby the area between the support part and the molded skin is foamed with polyurethane foam. In order for the air bag to be able to unfold in the passenger compartment in an accident, this molded part has to comprise means able to open this area. Usually, for practical purposes, it is contemplated that such coverings, at their reverse side, that is, the side facing away from the viewing side, have opening grooves, perforations or weakening lines in order to realize a bursting open of this area upon inflation of the air bag.

Users of motor vehicles usually require that such weakening lines are not visibly noticeable from the viewing side in the passenger compartment. Accordingly, this requires that the molded skin that is visible from the outside is provided only at the reverse side with a weakening and the weakening line or the opening groove is disposed in the molded part in such a way that either one is at a distance to the molded skin and thus will not become visible even when subjected the molded part is subject to long and increased stress. At the same time, in an accident, formation of an opening for the air bag without any problems has to be realized. This is conditioned on a precisely formed weakening line or opening groove which must be introduced into the molded skin.

In WO 97/03866, a plastic paneling is described where a weak spot is introduced at the interior side facing away from the viewing side by means of numerous sharp-edged recesses introduced from the interior side into the molded skin and that are part of tear seam which tears open upon the release and inflation of the air bag. WO 97/03866 contemplates that the tear seam is introduced in a separate work step into the molded part.

DE 196 51 758 A1 describes a vehicle interior paneling part which includes a breaking seam, whereby an air bag opening is formed when the air bag is activated. The formation of this seam is prepared during the injection molding process by forming the groove, which thereafter is deepened in a further process step by a so-called secondary notch by means of an ultra sound cutting device or a punch or similar tool after forming in the mold.

In DE 10 2004 030 786 A1, a method is described for introduction of a weakening groove of a multilayer composite comprised of support, back foaming and outer skin, wherein a predetermined break line is cut from the interior by a scalpel-type cutting process.

In DE 103 44 708 A1, a method and device are described for the production of an air bag covering, wherein after the injection molding process, the support component, while still in malleable condition, is provided with weakening grooves by hot embossing.

In DE 101 60 185 B4, the targeted weakening of the support of an interior paneling for an air bag module is described, wherein the formation of an outline for the air bag groove is introduced into the interior paneling prior to curing of the work material having been completed.

Besides these afore-described methods, numerous similar methods are known; however, the majority of the methods have the drawback that a separate work step with a suitable tool is necessary for the formation of the opening groove. Another drawback is oftentimes that the completely formed molded parts are hard to access with the cutting tools, thereby further aggravating the work step.

Thus, there is therefore a further need for a method, whereby in a simple manner and without increased additional expenditures, an opening groove for an airbag unfolding opening can be introduced into a molded part serving as a covering for an air bag.

This object is solved by means of a method with the features of claim 1. Advantageous embodiments of the method are reflected in the dependent claims.

Furthermore, object of the present invention is to provide a device for the production of an opening groove in a molded part having an air bag unfolding opening which assists in the production of such an air bag unfolding opening without a large increase in expenditure. This object is solved by means of a device with the features of claim 7.

It is a further object of the invention to provide molded parts that are produced according to the above method. The object is solved by means of molded parts with the features of claim 10.

Frequently, door panelings, molded parts for instruments or other parts for paneling the interior of a motor vehicle are produced in several work steps. Thus, for example, first a support part is injection molded in an injection mold. Among the starting materials for a support part are usually a thermoplastic material such as for example polypropylene (PP), styrol maleic acid anhydride-copolymer (SMA), polycarbonate-polybutylene terephthalate blends (PC/BPT), acryl nitril-butadiene styrol-polycarbonate-blends (ABS/PC), wherein these plastics are oftentimes reinforced with fibers and/or mineral stuffs. After solidifying of the thermoplastic material, the molded part is removed from the mold tool and together with the molded skin placed in a foaming tool, wherein the support part is, for example, connected to a molding stamp of the foaming tool, while the molded skin is placed onto the female mold. In this foaming tool, molded skin and support part are kept at a certain distance from each other and the space between the molded skin and the support part is filled with a foam material. Frequently, polyurethane is utilized as a foam material. The solidifying foam connects the molded skin and the support part into a molded part. Until now, after solidification of the foam, according to the prior art, the foamed molded part was released from the foaming tool and the required opening grooves or weakening lines subsequently introduced into the foam material and the support and partially also into the molded skin by means of an ultra sound punch, a milling unit or a cutting device or a laser.

It has been found that this expensive and additional work step can be saved, if a groove is introduced into the support part where the weakening spots are to be placed, already during the injection molding process prior to the solidification of the thermoplastic material, such that this spot in the support material will already be thinned. In order to introduce the groove, different methods can be applied. An advantageous method is one where the not yet solidified thermoplastic material is penetrated by a slider and to displace the plastic material so far so that only a thin layer remains, a so-called flash. This method has the advantage, as compared to a direct molding step, that relative exact and very thin layers can be realized. In a direct molding method where the groove is already pre-determined in the mold, such a thin flash is difficult to achieve, since it is difficult to place the thermoplastic material evenly in such a narrow slit. An additional problem arises also that the area of the support part, which swings open during the opening of the air bag as part of the cover, is completely surrounded by this opening groove, such that uniform injection molding of this portion of the molded part is additionally made more difficult by the narrow passage which is generated by the preformed groove.

In a second step, the support part with the pre-fabricated groove is removed from the mold tool and placed into the so-called foaming tool. The foaming tool includes, for example, a form stamp connected to the support part and a female mold into which a molded skin is placed. Molded skin and support are held at a certain distance from each other. The space between the support part and the molded skin, the so-called cavity is then foamed in the usual manner.

In accordance with the invention, the spots at the support part where the opening groove is supposed to be disposed, exhibit only a thin flash in direction of the cavity. This flash prevents that foam escapes during the foaming process, at the same time it is however so thin that it can be easily pierced by means of a cutting or punching device that is disposed at the foaming tool.

It is essential to the invention that during the foaming process, toward the end of the rising process and at the start of the congealing phase of the foam, the flash is pierced with a slider, which is a part of a punching tool and disposed at the foaming tool. The slider is thereby inserted into the not yet cured foam layer and remains there until the foam has solidified. After solidification of the foam, the slider is retracted such that a groove remains in the solidified foam in the shape of the slider. In a preferred embodiment of this device, the form of the slider is so selected that an after-treatment of the groove is no longer necessary.

The device according to the invention for producing molded parts that include an opening groove for an air bag unfolding opening comprises a mold tool for molding a support part and foaming tool for back foaming the support part, wherein the foaming tool is provided with a cutting- or punching device which includes a slider for piercing a flash.

In a preferred embodiment, the molding tool (injection molding tool) is provided with a slider for the formation of a groove.

The molded parts are preferably utilized of the interior paneling of motor vehicles, such as for example dash boards and side panelings.

Further features and advantages of the invention are described as follows with reference to the drawings, where it is shown in:

FIG. 1 an illustration of a section of a detail of a molded part placed in a foaming tool before the foaming process;

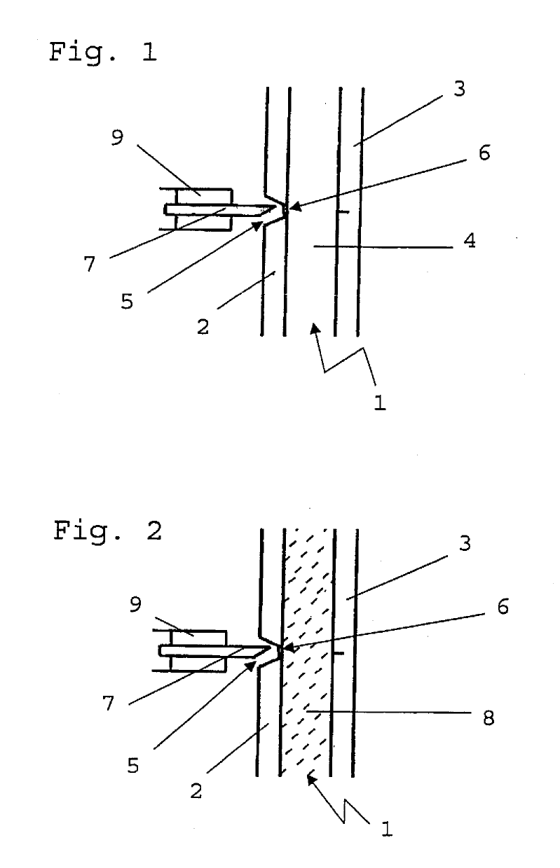

FIG. 2 the molded part of FIG. 1 during the foaming process;

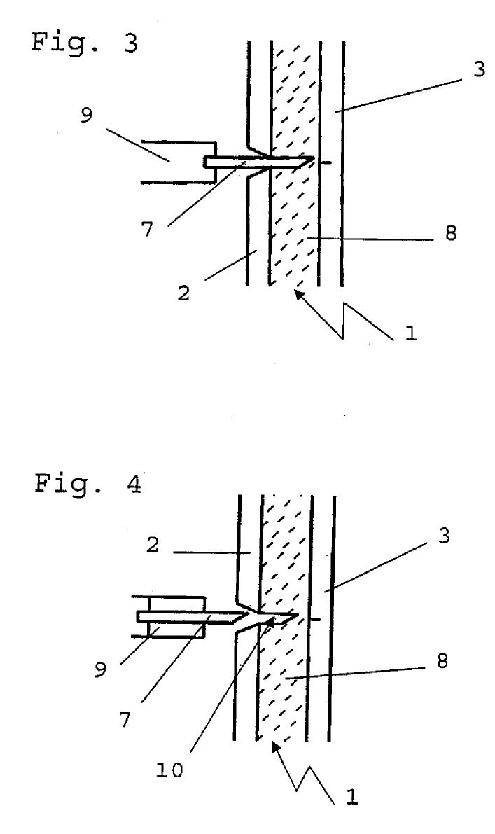

FIG. 3 the molded part of FIGS. 1 and 2 while introducing the opening groove by a slider;

FIG. 4 the completed molded part of FIGS. 1, 2 and 3 with an opening groove;

In FIGS. 1 to 4 the principle of the present invention is illustrated.

FIG. 1 shows a detail of a molded part 1 placed into the foaming tool, with a support 2 and a molded skin 3, wherein a cavity exists between the support part 2 and the molded skin 3. The support part 2 exhibits groove 5, which is provided with a flash 6 in direction of the cavity 4. At the level of groove 5, a punching unit is 9 is shown in the foaming tool which is also provided with a slider 7 slidable in the direction toward the groove 5.

FIG. 2 shows the molded part 1 of FIG. 1, wherein the cavity 4 is now filled with foam 8. The foam is usually polyurethane, however other foams that exhibit similar behavior as polyurethane can also be utilized.

FIG. 3 shows the molded part 1 of FIGS. 1 and 2, wherein the slider 7 is inserted through the flash 6 into the foam 8. In accordance with the invention, the slider remains in the foam 8 until it has solidified.

In FIG. 4, the molded part 1 of FIGS. 1 to 3 is shown, wherein the foam has solidified and the slider 7 is again retracted into its starting position in the punching device 9. The foam 8 now shows an opening groove 10 in the shape of the slider 7.

FIGS. 1 through 4 illustrate clearly the principle of the method according to the present invention where during the injection molding process, the support 2 is made thinner at the location where later the opening groove 5 is supposed to be formed. This thinning is preferably made by means of a slider, which is inserted into the thermoplastic material which is not yet entirely solidified. The advantage of using the slider for weakening this location is that interruption during the filling step in the injection molding process can be prevented and also that no flowing lines can form which could cause weak points in the solidified foam. Such weak points could lead to splintering of the molded part during inflation of the air bag whereby the flying splinters could injure passengers in the vehicle.

In the next step, the support part 2 with groove 5 and formed flash 6 is foamed together with the molded skin 3 in the foaming tool. In this manner, molded skin 3, foam 8 and support 2 form the molded part 1. During the foaming process, the slider is inserted through the flash 6 into the foam 9 which is not yet completely solidified. Due to the prior formation of groove 5 with flash 6, slider 7 can now easily be inserted without the necessity to heat the slider 7 beforehand. The formation of opening groove 10 in foam 8 by means of the unheated slider 7 has the additional advantage that the uniform solidifying of foam 8 is not impaired and thus a uniform extension of the opening groove realized.

### REFERENCE NUMBER LIST

1. molded part
2. support part
3. molded skin
4. cavity
5. groove (support part)
6. flash
7. slider
8. foam
9. punching unit
10. opening groove

1. A method for producing molded parts which include an opening groove for air bag unfolding opening and which include a support part, a molded skin and foam layer which is formed between the support and molded skin, wherein the method comprises the steps:
a) injection molding the support part in a mold tool
b) placing the injection molded support part and the molded skin into a foaming tool, whereby a cavity is formed between the molded skin and the support part, and
c) foam filling the cavity, wherein
i) upon injection molding the support, a groove is formed in the direction of the cavity which groove is provided with a flash,
ii) the flash is pierced with a slider during the subsequent foaming process, and
iii) wherein the slider remains in the solidified foam until an opening groove for an air bag unfolding opening is formed in the solidified foam.

2. The method according to claim 1, wherein the groove in support is formed during the injection molding process by inserting a slider into the not yet formed and solidified support.

3. The method according to claim 1, wherein piercing of the flash is carried out in the foaming tool toward the end of the rising process and at the beginning of the solidifying phase.

4. The method according to claim 1, wherein the slider includes a required end configuration corresponding to the opening groove.

5. The method according to claim 1, wherein the support part is molded from a reinforced or unreinforced thermoplastic material, in particular polypropylene (PP), polycarbonate-polybutylene terephthalate-blend (PC/PBT), acryl nitril-butadiene-styrol-polycarbonate-blend (ABS/PC) or styrol-maleic acid anhydride-copolymer (SMA).

6. The method according to claim 1, wherein the molded skin is formed from a thermoplastic material or an elastomeric reaction plastic material, e.g. polyurethane.

7. The method according to claim 1, wherein the foam is polyurethane foam.

8. A device for producing molded parts having an opening groove for an air bag unfolding opening, wherein the device is a mold tool for forming a support part and a foaming tool for back foaming the support, characterized in that the foaming tool is provided with a cutting- or punching device which includes a slider for piercing a flash according to a method according to claim 1.

9. The device according to claim 8, wherein the injection molding tool is provided with a slider for the formation of a groove.

10. Molded parts, in particular dash boards and door panelings for motor vehicles, produced according a method according to claim 1.
